(19) United States
(12) Patent Application Publication
(10) Pub. No.: US 2016/0018336 A1
(43) Pub. Date: Jan. 21, 2016

(54) METHODS AND KITS FOR ANALYZING AUTOMOTIVE FLUIDS

(71) Applicant: Ronald Schornstein, Mountain Lakes, NJ (US)

(72) Inventor: Ronald Schornstein, Mountain Lakes, NJ (US)

(21) Appl. No.: 14/801,928

(22) Filed: Jul. 17, 2015

Related U.S. Application Data
(60) Provisional application No. 62/026,350, filed on Jul. 18, 2014.

(51) Int. Cl. G01N 21/78

(52) U.S. Cl. CPC G01N 21/78; G01N 2021/752

(57) ABSTRACT

The invention provides kits and methods for assessing an automotive fluid and for determining if or when an automotive fluid should be or is in need of being replaced. The kit contains a test medium that may be a paper separated into two or more distinct, separable sections or compartments containing thereon an effective amount of at least one chemical or substance that effect or facilitate a color change in the presence of one or more substance, metal or impurity such as, for instance, iron, copper, or nickel. The test medium may be arranged in a substantially cubical form and contain multiple layers of test medium.

### FIELD OF THE INVENTION

The present invention is in the field of methods and kits for analyzing, assessing viability of, and detecting contaminants in or degradation of automotive fluids, such as, for instance, lubricating oils, brake fluid, power steering fluid, radiator fluid, and battery fluid.

### BACKGROUND OF THE INVENTION

Various methods, devices and kits have been developed for analyzing various characteristics of automotive fluids such as lubricating oils, engine oil, transmission fluids, greases, gear oils, hydraulic fluids, radiator fluids, brake fluids, antifreeze, coating system fluids, coolant fluids, and fuels such as diesel, gasoline, biofuels, and emulsified fuels. For instance, some methods for testing the condition of oil and the sludge content of oil include blotter, chromatography and chemical analysis. Some methods and devices for assessing the quality of used oil include placing a measured amount of oil upon an absorbent material, heating the sample, and waiting for the sample to disperse. The amount of undispersed sludge may then be measured and rated quantitatively. These methods, however, require significant controlled conditions, including measurement of the oil sample volume, and the use of a template to measure and rate the quantity of undispersed sludge and particles in the sample. Additionally, these methods include heating the sample, and waiting for the sample to disperse.

Markers have been used to identify and assess fluids, particularly petroleum based fluids. Proton accepting chemicals that at a particular concentration, for instance below about 50 milligrams per liter, provide little or no significant color to organic solvents have been used as markers. The marker may be dissolved in a liquid to be identified, and then subsequently detected by performing a chemical test on the marked liquid. The presence of a marker may be determined and even quantified, for instance, by extracting the fluid with an immiscible aqueous or significantly aqueous solution of an acid substance suitable for use with a particular marker. The acid may react with the basic compound to produce a visible, colored cation that is dissolved in the aqueous acid phase. U.S. Pat. No. 5,145,573 teaches such a method, and WO 03/078551 teaches a method where the acidic substance is applied to a test strip. The test strip is dipped into the oil and diazo-type marker reacts with the acidic substance in the test strip and changes color. The quantity of a marker may be measured such as by using visible light absorption spectrophotometry. The results may be compared with a reference standard to determine the original concentration of the marker in a fluid.

Borg, U.S. Pat. No. 2,889,736 teaches a light beam to determine approximate percentage of contaminants in oil, U.S. Pat. No. 3,049,964 teaches an optical means to indicate oil conditions, U.S. Pat. Nos. 3,578,865, 3,364,812, 3,731,743, 3,714,444, 3,734,629 all teach light as a source for testing oils for many unknowns. Hopkins, U.S. Pat. No. 3,182,255 teaches a capacitor sensor, Pricon, U.S. Pat. No. 4,082,511 teaches TAN and TBN testing, U.S. Pat. No. 4,651,560 teaches a filtration method. Wescott, U.S. Pat. No. 4,047,814 teaches a method for determining type, size and distribution of metallic particles in oil. U.S. Pat. No. 5,506,501 teaches preparing samples of oil by separating magnetic and non-magnetic particles. Joyces, U.S. Pat. No. 5,517,427 teaches an infrared spectrometer and an optical emission spectrometer for testing oil. Dickert, U.S. Pat. No. 5,262,732 teaches a capacitor grid sensor for determining contaminant levels. U.S. Pat. No. 5,817,928 teaches a method for evaluating a multiplicity of lubrication quality parameters. Thornton, U.S. Pat. No. 5,588,535 teaches a separation method where particles are separated as magnetic and non-magnetic and according to sizes. Sarkis, U.S. Pat. No. 3,526,127 teaches testing for viscosity, IR characteristics and metal content of an oil sample for particles between 5-15 microns.

Hergruth et al., U.S. Pat. No. 5,313,824 teaches another method to analyze oil by obtaining a sample of the oil, placing the sample upon a medium, maintaining the medium in a desired position for an effective period of time for the spot to be visible, visually comparing the spotted test medium to comparative visual indicia depicting lubricating oil in various conditions, and selecting the comparative example that most closely resembles the test medium spotted with the test sample. Hergruth et al. do not provide any chemical reaction occurring between the medium and the fluid. Rather, Hergruth et al. provide a test that features a visual observation of what the oil looks like as compared to a standard.

It would be desirable to provide a simple, rapid method to analyze an automotive fluid qualitatively to assess its condition, properties, age, origin, etc. The present invention provides such methods, tests and kits for rapidly and easily analyzing automotive fluids.

### SUMMARY OF THE INVENTION

The present invention provides kits, tests, and methods for assessing the quality of an automotive fluid. The tests and methods may be performed rapidly and without the need for sophisticated analysis equipment. The kits feature a test medium upon which an automotive fluid sample may be dispersed and instructions for observing visual indicia of a qualitative or quantitative characteristic of the automotive fluid.

In a first aspect, the invention provides a kit for assessing an automotive fluid. The kit contains a test medium upon which an automotive fluid sample may be placed or dispersed. The test medium may be a paper, and the paper may be separated into two or more distinct, separable sections or compartments by perforations. The perforations may allow for relatively easy detachment of one or more of the distinct, separable sections or compartments. In some instances, the test medium, which may be a paper, may be separated into three, four, five, six, seven, eight, nine, ten or more distinct, separable sections or compartments by perforations. The test medium may contain thereon in an effective amount, one, two, three, four, five, six, seven, eight, or nine or more chemicals or substances that effect or facilitate a color change in the presence of one or more substance, metal or impurity. The chemicals or substances that effect or facilitate a color change may be one or more of a-benzoin oxime, dimethylglyoxime, 1,10-phenanthroline, and cobalt chloride hexahydrate. The color change itself may be, for instance, from substantially white or neutral to, for instance, red, orange, reddish-orange, pink, green, blue, yellow, purple, etc. The color change may be produced within about 5, 10, 20, 30, 45, 60, 90, 120 or so seconds or within about 3, 4, or 5 minutes after contact with the automotive fluid. The color change may occur if one or more substance, metal or impurity is present in the automotive fluid in an amount of about 25, 50, 100, 200, 300, 400, or 500 or more parts per million (ppm). The one or more substance, metal or impurity may be one whose presence above a particular threshold value is indicative of deterioration, degradation, or pollution of an automotive fluid, and may be one or more of, for instance, water, iron, copper, nickel and oil. The one or more substance, metal or impurity may also be one or more of, for instance, cobalt, aluminum, lead, tin or chromium.

The test medium, such as a test paper, may be any one of a variety of absorbent media capable of receiving a sample of an automotive fluid. In many instances, when placed upon a suitable medium, the sample of automotive fluid will form a spot of any one of many shapes, including circular. The test medium, such as a test paper, may be arranged in a substantially cubical, rectangular, triangular, circular, elliptical, trapezoidal, etc. form and many contain multiple layers of test medium, such as a test paper. In some instances, there are 5, 10, 20, 25, 30, 50, 75, 100 or even 200, 300 or more such layers of test medium, such as a test paper. Each layer may be separable or divisible from one or more other such layers. Similarly, each test medium, such as a test paper, may be separable or divisible into distinct sections or compartments such as along perforations or cuts or partial cuts in the test medium, such as a test paper, itself

The kit may provide in addition to the test medium, one or more visual indicia depicting samples of an automotive fluid disposed upon the test medium. The kit may also provide one or more color charts demonstrating acceptable or unacceptable color changes on the test medium that are indicative of an acceptable or unacceptable characteristic of the automotive fluid. The kit may further include instructions or a descriptive text describing one or more of how obtain a sample of an automotive sample, how to prepare a sample of an automotive fluid, how to place or disperse a sample of an automotive fluid onto the test medium, and how to interpret a color change or lack of such a color change on the test medium. The instructions or a descriptive text may summarize the steps for using the kit that may generally correspond to the description of the method provided herein. The kit may optionally contain one or more devices useful for obtaining or storing an automotive fluid sample, such as, for instance, a syringe, a pipette, or a vial.

The automotive fluid may be one or more of a lubricating oil, engine oil, transmission fluid, greases, gear oil, hydraulic fluid, radiator fluid, brake fluid, antifreeze, coating system fluid, coolant fluid, and fuels such as diesel, gasoline, biofuels, and emulsified fuels. The fluid may be obtained from, for instance, a car, a motorcycle, a bus, a truck, a tractor, a boat, a ship, a recreational vehicle, or industrial or agricultural machinery. Similarly, the automotive fluid may be obtained from any suitable portion or compartment such as, for instance, internal combustion engines, turbines, transmissions, differentials, pumps, etc.

In a second aspect, the invention provides a method for analyzing an automotive fluid. The method features the steps of
a) obtaining a sample of an automotive fluid;
b) placing the sample upon the test medium,
c) maintaining the test medium in a desired position for an effective period of time;
d) visually comparing the test medium to one or more selected from the group consisting of a control, a standard, a color chart and a comparative visual indicia.

The method may further feature e) preparing the sample of the automotive fluid so that it is suitable for placing upon the test medium or so that it is suitable for undergoing a chemical reaction with a marker to produce a visual indicia of the presence of one or more substance, metal, degradation product or impurity. The preparing the sample of the automotive fluid may, for instance, feature mixing the sample of the automotive fluid with one or more solvent such as, for instance, water, to arrive at a desired or suitable concentration, viscosity, or pH.

The automotive fluid may be one or more of a lubricating oil, engine oil, transmission fluid, greases, gear oil, hydraulic fluid, radiator fluid, brake fluid, antifreeze, coating system fluid, coolant fluid, and fuels such as diesel, gasoline, biofuels, and emulsified fuels. The automotive fluid may be obtained from, for instance, a car, a motorcycle, a bus, a truck, a tractor, a boat, a ship, a recreational vehicle, or industrial or agricultural machinery. Similarly, the automotive fluid may be obtained from any suitable portion or compartment such as, for instance, internal combustion engines, turbines, transmissions, differentials, pumps, etc.

The test medium upon which an automotive fluid sample may be placed or dispersed may be present in a kit. The test medium may be a paper, and the paper may be separated into two or more distinct, separable sections or compartments by perforations. The perforations may allow for relatively easy detachment of one or more of the distinct, separable sections or compartments. In some instances, the test medium, which may be a paper, may be separated into three, four, five, six, seven, eight, nine, ten or more distinct, separable sections or compartments by perforations. The test medium may contain thereon in an effective amount, one, two, three, four, five, six, seven, eight, or nine or more chemicals or substances that effect or facilitate a color change in the presence of one or more substance, metal, degradation product or impurity. The chemicals or substances that effect or facilitate a color change may be one or more of α-benzoin oxime, dimethylglyoxime, 1,10-phenanthroline, and cobalt chloride hexahydrate. The color change itself may be, for instance, from substantially white or neutral to, for instance, red, orange, reddish-orange, pink, green, blue, yellow, purple, etc. The color change may occur if one or more substance, metal or impurity is present in the automotive fluid in an amount of about 25, 50, 100, 200, 300, 400, or 500 or more parts per million (ppm). The color change may be produced within about 5, 10, 20, 30, 45, 60, 90, 120 or so seconds or 3, 4, or 5 minutes after contact with the automotive fluid. The one or more substance, metal or impurity may be one whose presence above a particular threshold value is indicative of deterioration, degradation, or pollution of an automotive fluid, and may be one or more of, for instance, water, iron, copper, nickel and oil. The one or more substance, metal or impurity may also be one or more of, for instance, cobalt, aluminum, lead, tin or chromium.

The test medium, such as a test paper, may be any one of a variety of absorbent media capable of receiving a sample of an automotive fluid. In many instances, when placed upon a suitable medium, the sample of automotive fluid will form a spot of any one of many shapes, including circular. The test medium, such as a test paper, may be arranged in a kit in a substantially cubical, rectangular, triangular, circular, elliptical, trapezoidal, etc. form and many contain multiple layers of test medium, such as a test paper. In some instances, there are 5, 10, 20, 25, 30, 50, 75, 100 or even 200, 300 or more such layers of test medium, such as a test paper. Each layer may be separable or divisible from one or more other such layers. Similarly, each test medium, such as a test paper, may be separable or divisible into distinct sections or compartments such as along perforations or cuts or partial cuts in the test medium, such as a test paper, itself

The test medium may be provided or packaged in a kit that itself may provide in addition to the test medium, one or more visual indicia depicting samples of an automotive fluid disposed upon the test medium. The kit may also provide one or more color charts demonstrating acceptable or unacceptable color changes on the test medium that are indicative of an acceptable or unacceptable characteristic of the automotive fluid. The kit may further include instructions or a descriptive text describing one or more of how obtain a sample of an automotive sample, how to prepare a sample of an automotive fluid, how to place or disperse a sample of an automotive fluid onto the test medium, and how to interpret a color change or lack of such a color change on the test medium. The instructions or a descriptive text may summarize the steps for using the kit that may generally correspond to the description of the method provided herein. The kit may optionally contain one or more devices useful for obtaining or storing an automotive fluid sample, such as, for instance, a syringe, a pipette, or a vial.

In a third aspect, the invention provides a method for determining if or when an automotive fluid should be or is in need of being replaced. The method features the steps of
a) obtaining a sample of an automotive fluid;
b) placing the sample upon the test medium;
c) maintaining the test medium in a desired position for an effective period of time;
d) visually comparing the test medium to one or more selected from the group consisting of a control, a standard, a color chart and a comparative visual indicia.

The method may further feature e) preparing the sample of the automotive fluid so that it is suitable for placing upon the test medium or so that it is suitable for undergoing a chemical reaction with a marker to produce a visual indicia of the presence of one or more substance, metal, degradation product or impurity. The preparing the sample of the automotive fluid may, for instance, feature mixing the sample of the automotive fluid with one or more solvent such as, for instance, water, to arrive at a desired or suitable concentration, viscosity, or pH.

The automotive fluid may be one or more of a lubricating oil, engine oil, transmission fluid, greases, gear oil, hydraulic fluid, radiator fluid, brake fluid, antifreeze, coating system fluid, coolant fluid, and fuels such as diesel, gasoline, biofuels, and emulsified fuels. The automotive fluid may be obtained from, for instance, a car, a motorcycle, a bus, a truck, a tractor, a boat, a ship, a recreational vehicle, or industrial or agricultural machinery. Similarly, the automotive fluid may be obtained from any suitable portion or compartment such as, for instance, internal combustion engines, turbines, transmissions, differentials, pumps, etc.

The test medium upon which an automotive fluid sample may be placed or dispersed may be present in a kit. The test medium may be a paper, and the paper may be separated into two or more distinct, separable sections or compartments by perforations. The perforations may allow for relatively easy detachment of one or more of the distinct, separable sections or compartments. In some instances, the test medium, which may be a paper, may be separated into three, four, five, six, seven, eight, nine, ten or more distinct, separable sections or compartments by perforations. The test medium may contain thereon in an effective amount, one, two, three, four, five, six, seven, eight, or nine or more chemicals or substances that effect or facilitate a color change in the presence of one or more substance, metal, degradation product or impurity. The chemicals or substances that effect or facilitate a color change may be one or more of α-benzoin oxime, dimethylglyoxime, 1,10-phenanthroline, and cobalt chloride hexahydrate. The color change itself may be, for instance, from substantially white or neutral to, for instance, red, orange, reddish-orange, pink, green, blue, yellow, purple, etc. The color change may occur if one or more substance, metal or impurity is present in the automotive fluid in an amount of about 25, 50, 100, 200, 300, 400, or 500 or more parts per million (ppm). The color change may be produced within about 5, 10, 20, 30, 45, 60, 90, 120 or so seconds or 3, 4, or 5 minutes after contact with the automotive fluid. The one or more substance, metal or impurity may be one whose presence above a particular threshold value is indicative of deterioration, degradation, or pollution of an automotive fluid, and may be one or more of, for instance, water, iron, copper, nickel and oil. The one or more substance, metal or impurity may also be one or more of, for instance, cobalt, aluminum, lead, tin or chromium.

The test medium, such as a test paper, may be any one of a variety of absorbent media capable of receiving a sample of an automotive fluid. In many instances, when placed upon a suitable medium, the sample of automotive fluid will form a spot of any one of many shapes, including circular. The test medium, such as a test paper, may be arranged in a kit in a substantially cubical, rectangular, triangular, circular, elliptical, trapezoidal, etc. form and many contain multiple layers of test medium, such as a test paper. In some instances, there are 5, 10, 20, 25, 30, 50, 75, 100 or even 200, 300 or more such layers of test medium, such as a test paper. Each layer may be separable or divisible from one or more other such layers. Similarly, each test medium, such as a test paper, may be separable or divisible into distinct sections or compartments such as along perforations or cuts or partial cuts in the test medium, such as a test paper, itself.

The test medium may be provided or packaged in a kit that itself may provide in addition to the test medium, one or more visual indicia depicting samples of an automotive fluid disposed upon the test medium. The kit may also provide one or more color charts demonstrating acceptable or unacceptable color changes on the test medium that are indicative of an acceptable or unacceptable characteristic of the automotive fluid. The kit may further include instructions or a descriptive text describing one or more of how obtain a sample of an automotive sample, how to prepare a sample of an automotive fluid, how to place or disperse a sample of an automotive fluid onto the test medium, and how to interpret a color change or lack of such a color change on the test medium. The instructions or a descriptive text may summarize the steps for using the kit that may generally correspond to the description of the method provided herein. The kit may optionally contain one or more devices useful or obtaining or storing an automotive fluid sample, such as, for instance, a syringe, a pipette, or a vial.

The automotive fluid may be determined to be in need of being replaced if, for instance, one or more of one or more of iron, copper, nickel and oil is present above a threshold of, for instance, 50, 100, 200, 300, 400, or 500 or so parts per million (ppm). In some instances, antifreeze may be determined to be in need of being replaced Cu is above about 50 ppm. In other instances, oil may be determined to be in need of being replaced if iron is above 400 ppm, or copper is above 200 ppm, or nickel is above 50 ppm. In still other instances, brake fluid may be determined to be in need of being replaced if copper is above about 200 ppm or iron is above 200 ppm. In yet other instances, differential fluid may be determined to be in need of being replaced if iron is above 400 ppm or copper is above 100 ppm. In additional instances, power steering fluid may be determined to be in need of being replaced if copper is above about 200 ppm or iron is above 200 ppm. In further instances, transmission fluid may be determined to be in need of being replaced if iron is above 400 ppm or Ni is above 50 ppm. In still further instances, oil may be determined to be in need of being replaced if excess water is detected.

### BRIEF DESCRIPTION OF THE DRAWINGS

FIG. 1 represents a front and side view of a test kit in block form. The block may have, for instance, 50 to 100 sheets with each sheet used for a drop of automotive fluid to be tested. In some instances, the user can write date, vehicle, miles, tested by, etc. on each sheet result. Each sheet may test for the presence of one or more of iron, copper, nickel and oil.

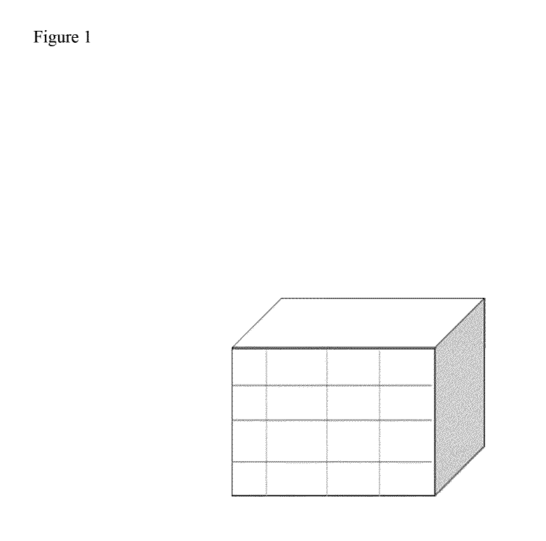

FIG. 2 represents a top view of a test kit according to FIG. 1 demonstrating a sheet used for a drop of automotive fluid to be tested. Each sheet may test for the presence of one or more of iron, copper, nickel and oil, and each sheet may contain perforations providing for easy detachment for each section used to test for the presence of one or more of the foregoing, respectively.

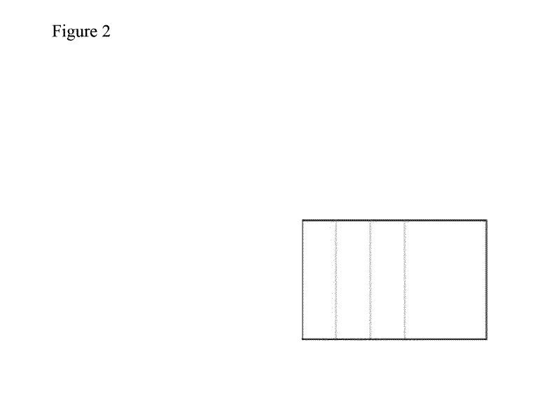

FIG. 3 represent a top view of a test paper that may be separate sheets or a single sheet divided into separate compartments for detecting the presence and amount of nickel (A), copper (B) and iron (C) in parts per million (ppm). In each instance a progressive and increasing color change is visible as the amount of each element increases respectively from 0 ppm to (A) 10, 20, 30, 40 and 50 ppm, (B) 50, 100, 150, 200, and 250 ppm, and (C) 100, 200, 300, 400 and 500 ppm. A color change occurs from substantially white to (A) pink, (B) green, and (C) orange-red.

### DETAILED DESCRIPTION OF THE PREFERRED EMBODIMENT

The present invention provides methods, devices and kits for analyzing automotive fluids. The analysis of used automotive fluids, such as lubricating oil, for instance, engine oil, depends upon dispersion of the automotive fluid on an absorptive medium. Many automotive fluids such as, for instance, oil, as they are used, develop contaminants including a component of sludge. When a sample of a used automotive fluid such as oil is obtained and the sample placed upon a suitable absorptive test medium, particular components may separate from the remainder of the sample. The amount and coloration of the sludge and contaminants in an automotive fluid sample provide a means for qualitative analysis of the test sample. Similarly, the amount or concentration of certain chemicals, substances, degradation products or metals, such as, for instance, copper, nickel and iron also provides a means for qualitative analysis of the test sample.

### Test Medium

The automotive fluid sample to be tested must be placed upon an appropriate test medium. Such a test medium results in relatively rapid dispersion of the automotive fluid sample, preferably within a few minutes, especially preferably within five minutes. The test medium may be an absorptive paper, such as chromatography paper. Other absorptive or adsorptive papers well known in the art are also acceptable as long as such papers are of sufficiently consistent physical composition to provide accurate test results. The test medium may differ in its porosity, density, wicking ability, or other physical characteristics as is known in the art. The shape or size of the test medium may vary as long as it is of an effective size to permit dispersion of the automotive fluid sample and small enough to be economical.

The automotive fluid sample may or may not be precisely measured. The sample may be obtained, for instance, using a dipstick or other similar means. An exemplary sample size may be a single drop, multiple drops, or a few milliliters. A test medium may be disposed to receive a sample such as a drop of the automotive fluid to be tested from the end of a dipstick. In a preferred embodiment of the invention, the test medium used is a piece of white colored test paper measuring approximately 1, 2, 3, or 4 or 5 or so inches along a first side and 1, 2, 3, or 4 or 5 or so inches along a second, perpendicular or intersecting side. The test medium may contain thereon in an effective amount, one, two, three, four, five, six, seven, eight, or nine or more chemicals or substances that effect or facilitate a color change in the presence of one or more substance, metal or impurity. The chemicals or substances that effect or facilitate a color change may be one or more of a-benzoin oxime, dimethylglyoxime, and 1,10-phenanthroline.

### Visual Indicia

Qualitative analysis of the test sample is accomplished by visual comparison of the completed test sample to visual indicia, provided as a part of the test kit. The visual indicia may be, for instance one or more color charts or a written description of color change. The amount of color change may represent a relative concentration of one or more chemicals, substances, degradation products or metals in an automotive fluid. The color chart may feature a printed sheet containing depictions of one or more colors that correlate to a relative concentration of one or more chemicals, substances, degradation products or metals in an automotive fluid.

### Test Method

The methods provided for the analysis of an automotive fluid are effective, relatively simple, and may be performed relatively quickly in uncontrolled conditions by untrained users. The sample does not necessarily need to be obtained during actual operation of the engine or other equipment. The sample may be obtained at any time before, during or after operation of the engine or equipment. The sample may be obtained using a dipstick provided as a part of the engine, transmission or other equipment or using a syringe or pipette that may be optionally provided in the kits described herein. Once the automotive fluid sample is placed on the test medium, it disperses. In order to provide consistent dispersion, the test medium should be kept in a desired position such as, for example, horizontal, vertical, etc.

### Evaluate the Condition of Automotive Fluids for Evidence of Corrosion.

Multiple automotive fluids including brake fluid, motor oil, power steering fluid, transmission fluid, and differential fluids obtained from, for instance, remote engines, automobiles and trucks may all be so evaluated. Evidence of corrosion may include the presence of or elevated concentrations of metals in solublized ionic form.

The test provides a general test for metals found in fluids in ionic form. The extraction of such ions into water and treatment with organic ligands provides a detectible color change that can be compared against a chart or using a photometer if greater quantification is desired. However, a basic indicator is normally sufficient to warrant a fluid change or further examination of the source of the automotive fluid, for instance, the engine.

If an abrasive process is occurring in an automobile or vehicle, but the process isn't necessarily corrosive, a metal-detector apparatus provides a better indication of mechanical wear. In the case of corrosion, metals such as iron, nickel and copper are present in ionic, water-soluble forms. Testing for ionic transition metals involves ligands of any kind to produce visibly colored coordination complexes. 1,10-Phenanthroline and 2,2′-bipyridine are two ligands effective for detecting iron, nickel and copper.

Zinc and tin are normally colorless in these methods, but that is beneficial since zinc additives may be placed in oil to seal pistons in old engines so that the methods do not produce false positives. Corrosion of solder is always accompanied by copper. Therefore, the presence of other metals such as lead, indium, zinc and tin do not inform the tester beyond the presence of copper.

### Levels of Metals in Automotive Fluids

Engineers, and auto makers (OEMs Original Equipment Manufacturers) have shown that the cleaner the oil the longer an engine, power steering, transmission, differential will last. While there are many ways to delay and filter out metals, monitoring their level assists in deciding when to change the fluids. No oils available prevent damage from high levels of metal particles. Excessive metal particles, heat and the demand of stop and go driving can rapidly accelerate wear. The following Table 1 provides the upper limits of certain metals in certain automotive fluids expressed as parts per million (ppm).

TABLE 1
Wear Metal Limits (ppm)

| | Iron | Chrome | Nickel | Al | Copper | Lead | Tin |
|---|---|---|---|---|---|---|---|
| Diesel | 390 | 40 | 30 | 45 | 325 | 128 | 40 |
| Natural Gas | 175 | 15 | 6 | 25 | 160 | 270 | 20 |
| Hydraulic | 165 | 15 | 14 | 40 | 255 | 98 | 30 |
| (power | | | | | | | |
| steering | | | | | | | |
| Gear Box | 985 | 25 | 63 | 55 | 250 | 196 | 50 |
| (Trans/Diff) | | | | | | | |
| Brake | 200 | NA | NA | NA | 200 | NA | NA |
| Antifreeze | 10 | NA | NA | 30 | 10 | NA | NA |
| Coolant | | | | | | | |

### EXAMPLE 1

This test reveals oxidation products, sludge formation, dispersancy failure, glycol contamination, water contamination, fuel dilution, and high levels of particles in motor oil such as crankcase oil. One or two drops of used oil are placed on the surface of a page of the test paper provided in the kit. The test paper may be positioned flat so that all but the four edges of the paper are suspended. The test paper absorbs the oil drops over a period of seconds to a few minutes. Once the oil sample has been drawn into the pores of the test paper, the condition of the oil may be evaluated.

Visual inspection of the test paper containing the oil sample may be evaluated to assess characteristics of the oil as follows in Table 2:

TABLE 2

| | |
|---|---|
| colorless spot or slight yellow | Acceptable |
| Develops dense, dark appearance | Fail for Dispersancy |
| Develops black pasty appearance; Shape of | Fail Antifreeze Coolant in |
| sample may be irregular. | the oil |
| Develops dark center with distinct outline | Fail Severely oxidized |
| Develops dark center rings, or irregular | Fail Fuel in Oil |
| shape | |

Acceptable indicates oil may be safely used
Fail indicates oil should be replaced

The effects of coolant and antifreeze contamination are many. One is simply an increase in the viscosity or a thickening of the oil. This often produces a thick gel or emulsion when mixed with the oil. Acids such as glycolic acid, formic acid, and other organic acids may be formed. Flow is restricted as this oil moves throughout an engine. It can occlude to the walls and narrow passageways, and interfere with oil flow, causing partial or total starvation where the oil is intended to go. It is common for glycol and these emulsions and gels to completely block flow-through filters. This is reported to be a primary cause of premature filter failure in a diesel engine and overall poor lubrication.

Glycol contamination is common in engine oils and can greatly alter the properties of the lubricant. Antifreeze causes a thickening of the oil, increasing the viscosity and reducing flow. This can lead to boundary conditions in parts of the engine that require a less viscous fluid to properly lubricate and protect them. It also may create an acidic environment within the oil, resulting in corrosion within the system, especially on copper surfaces. Additives within oil may be compromised as well. Antifreeze also mixes with oil to form small globules or oil balls. Although very small, typically 5 to 40 microns in size, they may cause problems. These balls are abrasive and create surface erosion. This commonly occurs on the inside walls of the cylinder, where the oil balls may cut and gouge into the wall. They may produce surface fatigue and lead to lubrication failures in areas of very tight tolerances. Confirmation of an antifreeze leak can be accomplished with a UV dye and blacklight test. Many are commercially available including ACUSTRIP Company, Inc

Other automotive fluids may be assessed in a similar manner. Samples of the automotive fluid are obtained and the samples handled as described following. Mix the automotive fluid in a vial with 50% water. Mix well and allow to set. Obtain a sample of the water (at the bottom) with a pipette. Drop a drop onto the test paper. Allow the drop to be absorbed by the paper.

Antifreeze is assessed as Fail if Cu is above 10 ppm

Oil is assessed as Fail if Fe is above 400 ppm, or Cu is above 200 ppm, or Ni is above 50 ppm

Brake Fluid is assessed as Fail if Cu is above 200 ppm, or Fe is above 200 ppm

Differential Fluid is assessed as Fail if Fe is above 400 ppm or Cu is above 100

Power Steering Fluid is assessed as Fail if Cu is above 200 ppm or Fe is above 200 ppm

Transmission Fluid is assessed as Fail if Fe is above 400 ppm or Ni is above 50 ppm

### EXAMPLE 2

### Detection of Metals in Automotive Fluids

Ligands specific to gravimetric and colorimetric analysis were purchased from Sigma-Aldrich (along with samples of the metals to be tested as standards). Below are the general structures or phenanthroline and bipyridine (bipyridine is shown in two isomeric forms) the metal complexes of which are colored depending on the metal.

Each ligand was dissolved in 25 ml of 95% ethanol forming a 1 wt % ethanolic solution of each ligand, for each metal. Test papers were marked to distinguish three sections for application. The sections were soaked with each solution, separately and were left to air-dry.

A test sample was extracted by shaking with an equal volume of distilled water and allowed to separate. The water phase can be applied to the dry strips. The system was allowed to develop for about 60 seconds. The test strips were then compared against a chart or color legend for each metal giving some information about concentration. The color changes were perfectly linear in intensity with concentration, and so fading the color from a standard solution back to pure white provided an accurate assessment of concentration. For iron for instance, 500 ppm 250, 125, 60, and 30 ppm (halving the starting concentration 4 times is sufficient to read for significant iron). Similar methods may be used for nickel and copper, even though they are present at lower concentrations, e.g. 50 ppm and aren't as saturated in color, e.g. 50 ppm, 25 ppm 12 ppm. Three frames of legend should reach the visual limit of detection for those metals. Below are the ligand systems and their reactions with metals copper, nickel and iron, respectively:

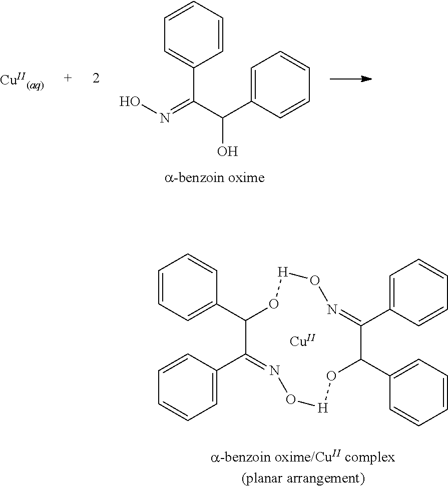

Copper sulfate aqueous, even at 250 ppm, is barely detectable visually.

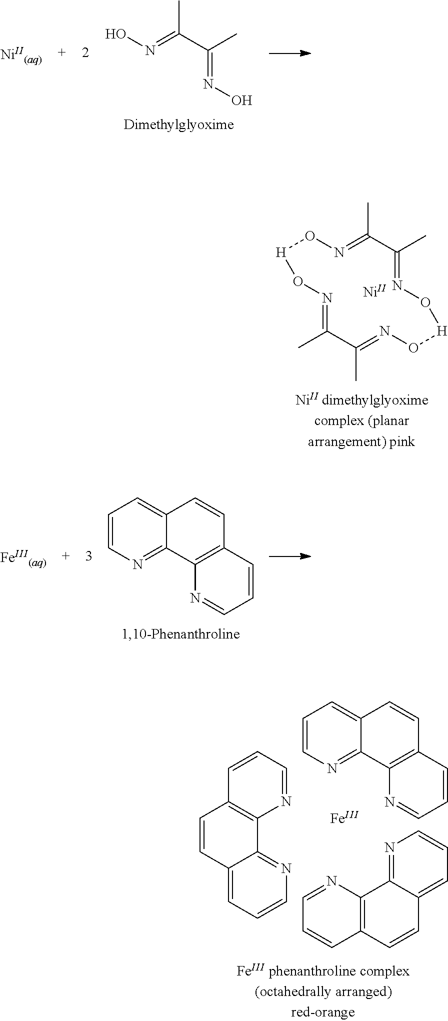

Table 3 provides the calculations for the generation of upper limit aqueous solutions for five metals. Chromium and cobalt test a true negative for all three ligands. The left most part of the ratio arises from the desired limit, the middle part of the equation reflects the ratio of atomic metal ions attended by the weight of the anions and waters of hydration, and the rightmost part of the ratio dictates the amount of solution volume used (e.g., 100 grams water˜100 ml water):

TABLE 3
$\frac{50 g Cr 266.45 g {CrCl}_{3} 6 {H}_{2} O 100 g}{1 , 000 , 000 g water 52.00 g Cr sample} = 26 mg$
$\frac{50 g Ni 145.61 g {NiCl}_{2} {H}_{2} O 100 g}{1 , 000 , 000 g water 58.69 g Ni sample} = 13 mg$
$\frac{500 g Fe 287.02 g {FeSO}_{4} 7 {H}_{2} O 25 g}{1 , 000 , 000 g water 55.85 g Ni sample} = 62 mg$
$\frac{250 g Cu 267.70 g {CuSO}_{4} 6 {H}_{2} O 25 g}{1 , 000 , 000 g water 63.55 g Cu sample} = 26 mg$
$\frac{50 g Co 237.93 g {CoCl}_{2} 6 {H}_{2} O 100 g}{1 , 000 , 000 g water 58.93 g Co sample} = 20 mg$

Iron (II) sulfate eventually becomes Fe (III) sulfate through conversion by air and test solutions can take on a rusty look. This does not affect the test, nor does phenanthroline favor one form over another.

### Basic Instructions for Use

A bottle containing equal amounts of automotive fluid sample, and deionized water (free of ions) is shaken and allowed to settle. A test medium such as a paper test strip is laid down. Drops of water from the shaken sample are added at one end of the strip, and the solution is added until the cut pieces are saturated. The iron (II, or III) ion test (center) exhibits results immediately, and the red-orange color can be compared to a legend in the supplied quantitative color chart. The adjacent strips that indicate the presence of nickel (II) and for copper (II) ions take about a minute for the full development of pink and green to be complete. A similar quantification by the color legend can be obtained anytime after that.

### EXAMPLE 3

### Construction of Papers for Detection of Metals in Automotive Fluids

Several wide strips of Whatman #4 filter paper (or equivalent without metals) were cut, and two slices were made in these wide strips so that three tails on the strip connected by a paper base were formed. Several strips were stacked, and each group of strips are bent out of each other's way. The following solutions were taken up by capillary action into each group of strips:
0.5 grams alpha-benzoinoxime dissolved in 25 ml ethanol
0.5 grams 1,10-phenanthroline dissolved in 25 ml ethanol
0.5 grams dimethylglyoxime suspended in 25 ml ethanol

The saturated strips were allowed to air-dry, and the book of strips were flattened, stacked, and sealed in a polyethylene bag. There is little concern for cross contamination after the paper is dry. The base of the strip for the dimethylglyoxime solution were cut (nicked for nickel) to distinguish the lanes for expected colors.

### EXAMPLE 4

Detecting the condition of and the presence of metals in an automotive fluid such as oil

This test reveals oxidation products, sludge formation, viscosity, glycol contamination, water contamination, fuel dilution, and high levels of particles in motor oil (crankcase oil).

Methods

1. Visual Inspection of the Oil

Place one or two drops of used oil on the surface of the test paper. Lay the test paper flat so that all but the 4 edges of the paper are suspended. The test paper may be suspended on clips such as paper clips or pencils or pens. Wait for the test paper to absorb the oil drop(s) for a few minutes. Once all of the oil has been absorbed and drawn into the pores of the test paper, evaluate the condition of the oil. Table 4 provides some general visual indicia that may be observed for evaluating the condition of the oil.

TABLE 4
Oil Test

| | |
|---|---|
| colorless spot or slight yellow | Acceptable |
| Develops dense, dark appearance | Fail for Dispersancy |
| Develops black pasty appearance; | Fail Antifreeze Coolant in the oil |
| Shape of sample may be irregular. | |
| Develops dark center with distinct | Fail Severely oxidized |
| outline | |
| Develops dark center rings, or | Fail Fuel in Oil |
| irregular shape | |

In this context, “Fail” means generally that the oil should be replaced or is in suboptimal condition.

2. Determining the Amount of Metals in the Oil

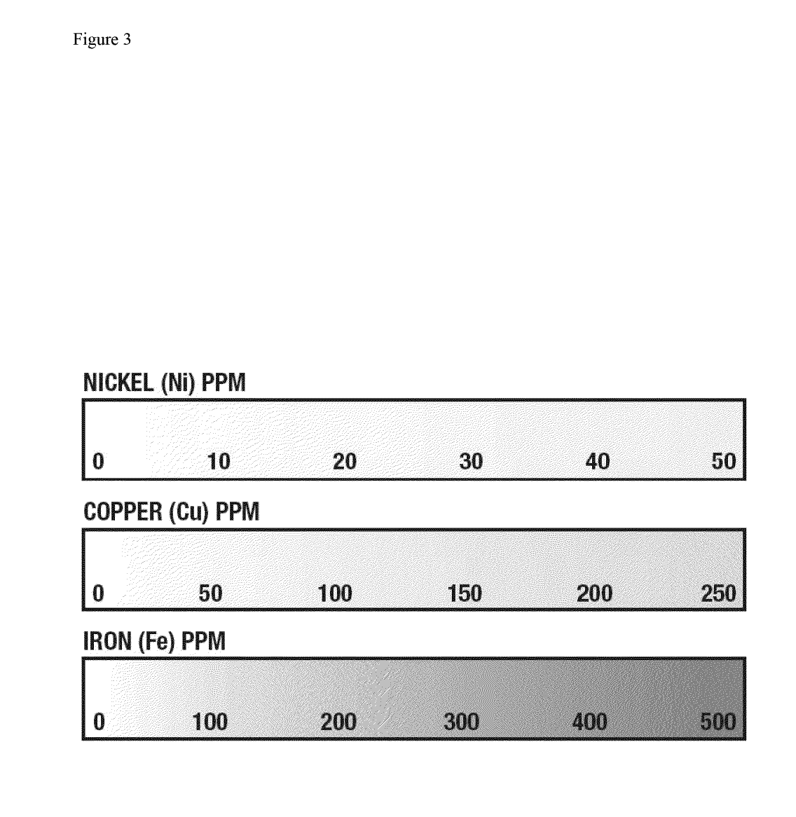

Obtain a small sample (about lmL) of used oil in an ampoule. Shake the sample well and allow it to set for a few seconds or minutes. Squeeze a droplet out of the ampoule onto each separate column or compartment of the test paper (FIG. 3). Let the droplet be absorbed by the paper. Visually review the results as follows:

OIL: Fail if Iron is above 400 ppm, Copper is above 200 ppm, or Nickel is greater than 50 ppm

In this context, “Fail” means generally that the oil should be replaced or is in suboptimal condition.

Table 5 provides some amounts of certain metals present in other automotive fluids that may be used for evaluating the condition of the automotive fluid. Presence of one or more of these metals in amounts above the thresholds provided in parts per million (ppm), leads to a judgment of “Fail” for the particular automotive fluid.

TABLE 5
Automotive Fluid Test

| | |
|---|---|
| BRAKE FLUID | Fail if Copper is above 200 ppm or if Iron is |
| | above 200 ppm |
| DIFFERENTIAL OIL | Fail if Iron is above 400 ppm or if Copper is |
| | above 100 ppm |
| POWER STEERING | Fail if Copper is above 250 ppm or if Iron is |
| | above 200 ppm |
| TRANSMISSION FLUID | Fail if Iron is above 400 ppm or Nickel is |
| | above 50 ppm |

In this context, “Fail” means generally that the oil should be replaced or is in suboptimal condition.

### EXAMPLE 5

### Detecting the Presence of Water in Oil

When water enters into a closed oil-based system, it can lead to performance problems in that system. The presence of water may lead to an increase in wear and tear on the system and corrosion that may cause system failure. Therefore, it is important to test for the presence of water in oil.

### Construction of Papers for Detection of Water in Oil

One gram of commercially available cobalt chloride hexahydrate is dissolved in 25 ml deionized water to form a bright magenta solution. The solution is applied directly to strips of Whatman #4 filter paper, or an equivalent, just saturating the paper. The excess solution is recovered, and the strips of paper are placed in a glass dish or some other non-metal, non-pourous object. The dish is put in an oven pre-set to approximately 120° C. along with silica gel desiccant packets and glass containers that will eventually be used to contain and keep the test papers dry. Allow the dish containing the test papers to remain in the over for about 1 hour. As the solution dries thoroughly, the test papers turn from light pink to sky blue. After the test papers become dry and easier to handle, the test papers are stacked, into the glass containers while still hot and dry. The silica desiccant packet is placed inside the glass containers, and they are sealed immediately. The assembled glass container may be returned without caps to the oven for another 30 minutes to 1 hour, heated again, and capped while hot. After removal from the oven, and cooling, the strips are ready for use.

### Methods.

Obtain a sample of oil, for instance, from the bottom of the oil pan. Allow the oil sample to sit for 1 minute until it settles. Immerse a test strip without contaminating it, e.g. using forceps or tweezers, into the oil sample. The presence of excess water is indicated by an immediate change of all or part of the area on the strip to pale pink. Spotty but immediate changes within a few seconds indicate near saturation.

While preferred embodiments of the invention are illustrated and described, it will be appreciated that various changes can be made therein without departing from the spirit and scope of the invention, with the scope of the present invention being defined only by the following claims.

1. A kit for assessing an automotive fluid comprising a test paper wherein an automotive fluid sample may be placed or dispersed on the test paper, wherein the test paper is separated into two or more distinct, separable sections or compartments, and wherein the test paper contains thereon an effective amount of a chemical or substance that effects or facilitates a color change in the presence of one or more substance, metal or impurity.

2. The kit according to claim 1 wherein the chemical or substance that effects or facilitates a color change is selected from the group consisting of cobalt chloride hexahydrate, α-benzoin oxime, dimethylglyoxime, and 1,10-phenanthroline.

3. The kit according to claim 1 wherein the color change occurs if the one or more substance, metal or impurity is present in the automotive fluid in an amount of at least 10 parts per million (ppm).

4. The kit according to claim 1 wherein the one or more substance, metal or impurity is present above a particular threshold value after deterioration, degradation, or pollution of an automotive fluid.

5. The kit according to claim 1 wherein the one or more substance, metal or impurity is selected from the group consisting of water, iron, copper, and nickel.

6. The kit according to claim 1 wherein the test paper is arranged in a substantially cubical form.

7. The kit according to claim 1 wherein the test paper is present in multiple layers.

8. The kit according to claim 1 comprising at least 10 layers of test paper.

9. The kit according to claim 1 further comprising one or more color charts demonstrating acceptable or unacceptable color changes on the test paper that are indicative of an acceptable or unacceptable characteristic of the automotive fluid.

10. The kit according to claim 1 further comprising instructions or a descriptive text describing one or more of how to obtain a sample of an automotive sample, how to prepare a sample of an automotive fluid, how to place or disperse a sample of an automotive fluid onto the test paper, and how to interpret a color change or lack of the color change on the test paper.

11. The kit according to claim 1 wherein the test paper is separated into four or more distinct, separable sections or compartments.

12. The kit according to claim 1 wherein the test paper is separated into two or more distinct, separable sections or compartments by perforations.

13. A method for analyzing an automotive fluid comprising the steps of:
a) obtaining a sample of an automotive fluid;
b) placing the sample upon a test medium,
c) maintaining the test medium in a desired position for an effective period of time;
d) visually comparing the test medium to one or more selected from the group consisting of a control, a standard, a color chart and a comparative visual indicia.

14. The method according to claim 13 further comprising e) preparing the sample of the automotive fluid so that it is suitable for placing upon the test medium.

15. The method according to claim 14 wherein e) preparing the sample of the automotive fluid may comprises mixing the sample of the automotive fluid with one or more solvent.

16. The method according to claim 13 wherein the automotive fluid is selected from the group consisting of a lubricating oil, engine oil, transmission fluid, a grease, gear oil, a hydraulic fluid, a radiator fluid, a brake fluid, antifreeze, a coating system fluid, a coolant fluid, diesel, gasoline, a biofuel, and an emulsified fuel.

17. The method according to claim 13 wherein the test medium is a test paper separated into at least two distinct, separable sections or compartments by perforations.

18. The method according to claim 17 wherein the test paper comprises one or more chemicals or substances that effect or facilitate a color change in the presence of one or more substance, metal, degradation product or impurity.

19. The method according to claim 18 wherein the one or more substance, metal or impurity is selected from the group consisting of water, copper, iron, and nickel.

20. A method for determining if or when an automotive fluid should be or is in need of being replaced comprising the steps of:
a) obtaining a sample of an automotive fluid;
b) placing the sample upon the test medium;
c) maintaining the test medium in a desired position for an effective period of time;
d) visually comparing the test medium to one or more selected from the group consisting of a control, a standard, a color chart and a comparative visual indicia.
